(19) United States
(12) Patent Application Publication
(10) Pub. No.: US 2025/0378006 A1
(43) Pub. Date: Dec. 11, 2025

(54) ADAPTIVE CODE PACKAGING INTERFACE FOR CUSTOMIZABLE SINGLE PAGE APPLICATION ENVIRONMENTS

(71) Applicant: BANK OF AMERICA CORPORATION, CHARLOTTE, NC (US)

(72) Inventors: Shashank Shrihari Lolam, Mumbai (IN); Sandeep Kumar Chauhan, Miyapur (IN); Shailesh Nyeland Lolam, Glendale, AZ (US)

(73) Assignee: BANK OF AMERICA CORPORATION, CHARLOTTE, NC (US)

(21) Appl. No.: 18/734,410

(22) Filed: Jun. 5, 2024

(51) Int. Cl. G06F 11/36; G06F 8/41; G06F 8/60; G06F 8/71; G06F 11/34

(52) U.S. Cl. CPC G06F 11/3612; G06F 8/41; G06F 8/60; G06F 8/71; G06F 11/3466; G06F 11/3688; G06F 11/3696

(57) ABSTRACT

Systems, computer program products, and methods are described herein for an adaptive code packaging interface for customizable single page applications. The present disclosure is configured to define merchant requirements by gathering and analyzing specific information, develop and compile new source code based on these requirements, generate an assembly from the compiled code, and configure deployment parameters tailored to a merchant context. An intelligent deployment tool is used to select Single Page Application (SPA) components from a library, leveraging large language models and prompt engineering. The selected SPA components and custom code are merged into a cohesive deployment package, which is then deployed to application servers. The deployment is validated through tests and performance monitoring to ensure functionality and identify areas for improvement. This system enhances flexibility, efficiency, and adaptability in the deployment of SPAs.

### TECHNOLOGICAL FIELD

Example embodiments of the present disclosure relate to adaptive code packaging interface for customizable single page application.

### BACKGROUND

Merchant services require diverse solutions tailored to the specific needs of different types of merchants. Independent Software Vendors (ISVs) play a critical role in customizing user interfaces for improved merchant business operations. However, current methods do not allow for the integration of multiple Single Page Applications (SPAs) within a single container to achieve desired functionality. This limitation necessitates the development of a solution that supports the adaptive packaging and deployment of multiple SPAs.

Applicant has identified a number of deficiencies and problems associated with existing methods for adaptive code packaging interfaces for customizable single page applications. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for an adaptive code packaging interface for customizable single page applications.

The disclosed solution encompasses an intelligent deployment tool configured to work with configuration stores to select appropriate configurations based on customer requirements. Utilizing prompt engineering and large language models (LLM), the system is trained to identify and select suitable SPA components, which are then processed by an SPA processor. The processor interprets meta-information associated with each SPA to determine the appropriate components for assembly. The solution also allows for each SPA component to be configured and merged into the deployment package. All SPA components, along with custom code, are packaged together by the deployment tool before being deployed to application servers.

As such, embodiments of the invention relate to systems, methods, and computer program products for adaptive code packaging interface for customizable single page applications the invention including the general steps of: generate merchant requirements by gathering and analyzing information specific to a merchant's services, operational environment, and needs; compile source code based on the merchant requirements, including custom functionalities and enhancements necessary for a deployment package; generate an assembly from the compiled source code by organizing the source code into a structured unit comprising necessary components and dependencies; configure deployment parameters to tailor the deployment package to a merchant context comprising settings for server specifications and deployment environment; transmit instructions to an intelligent deployment tool to select appropriate Single Page Application (SPA) components from a library via a large language model and prompt engineering to ensure compatibility and suitability; merge the appropriate SPA components and the compiled source code into the deployment package; deploy the deployment package to application servers via executing deployment scripts to install and configure the application; and validate deployment via conducting one or more tests to ensure functionality and monitor application performance.

In some embodiments, the step of defining merchant requirements further comprises storing gathered information in a merchant database for future reference and analysis.

In some embodiments, the step of developing and compiling the source code includes using a version control system to manage changes and track history of the source code.

In some embodiments, the intelligent deployment tool further comprises a parameter reader that interprets the configuration parameters and guides the selection of the SPA components.

In some embodiments, the step of generating the assembly from the compiled source code comprises integrating third-party libraries and dependencies required for the SPA components.

In some embodiments, the deployment parameters include security settings to ensure a deployed application complies with one or more security policies and regulations of a merchant.

In some embodiments, validation further comprises automated testing tools to conduct functional, performance, and security tests on the deployed application.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for adaptive code packaging interface for customizable single page application, in accordance with an embodiment of the disclosure;

FIG. 2 illustrates a process flow 200 for adaptive code packaging interface for customizable single page application, in accordance with an embodiment of the disclosure;

FIG. 3 illustrates a process flow 300 for adaptive code packaging interface for customizable single page application, in accordance with an embodiment of the disclosure; and

FIG. 4 illustrates a process flow for adaptive code packaging interface for customizable single page application, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “Large Language Model” (LLM) refers to an advanced artificial intelligence system designed to understand, generate, and manipulate human language at a high level of proficiency. These models are trained on extensive datasets encompassing diverse forms of text from various sources, enabling them to perform a wide range of natural language processing tasks. LLMs are characterized by their ability to generate coherent and contextually relevant responses, complete sentences or paragraphs, translate languages, summarize text, answer questions, and more. They achieve this through sophisticated algorithms that leverage deep learning techniques, including neural networks with numerous layers and parameters. Examples of tasks that LLMs can handle include text prediction, language translation, sentiment analysis, and conversational interfaces. LLMs are integral to applications requiring human-like text comprehension and generation capabilities, making them essential tools for developing intelligent, adaptive systems.

As used herein, an “Independent Software Vendor” (ISV) refers to an entity or individual that develops, markets, and sells software solutions designed to run on one or more computer hardware or operating system platforms. ISVs are independent of the hardware or operating system vendors, and they create software that provides specific functionalities tailored to meet the diverse needs of various businesses or users. In the context of this disclosure, ISVs play a crucial role in customizing user interfaces for merchant services, thereby enhancing business operations.

As used herein, a “Single Page Application” (SPA) refers to a web application or website that interacts with the user by dynamically rewriting the current page rather than loading entire new pages from a server. This approach results in faster transitions and a more seamless user experience. SPAs are designed to provide a more fluid and responsive experience by loading necessary resources once and then updating content as the user interacts with the application.

As used herein, “Prompt Engineering” refers to the process of designing and refining input prompts to optimize the performance and output of large language models (LLMs). This involves crafting specific queries or commands that guide the LLM to generate the desired response or action. Effective prompt engineering is essential for harnessing the full potential of LLMs in various applications, ensuring accurate and contextually relevant outputs.

As used herein, an “Intelligent Deployment Tool” refers to a sophisticated software utility that automates the process of configuring, assembling, and deploying applications based on specific parameters and requirements. This tool leverages advanced algorithms, including those provided by large language models, to select appropriate components and configurations. It ensures that the deployment process is efficient, accurate, and tailored to the unique needs of each user or system.

As used herein, a “Smart Contract” refers to a self-executing contract with the terms of the agreement directly written into lines of code. Smart contracts are stored on a blockchain and automatically enforce the conditions and actions agreed upon by the parties involved. In the context of this disclosure, smart contracts are used to automate and ensure the accuracy of the deployment process, verifying that each deployment meets the specified requirements.

As used herein, “Configuration Parameters” refers to a set of predefined settings and options that determine how a software application or system behaves. These parameters can include variables related to performance, functionality, user preferences, and system requirements. In the context of this disclosure, configuration parameters guide the intelligent deployment tool in selecting and assembling the appropriate SPA components for deployment.

As used herein, a “Deployment Package” refers to a bundled collection of software components, configurations, and dependencies that are prepared and packaged together for deployment to a target environment. This package ensures that all necessary elements are included and configured correctly, facilitating a smooth and efficient deployment process. The deployment package is the final deliverable that is deployed to application servers and end-user devices.

As used herein, “Meta Information” refers to data that provides information about other data within a system. In the context of this disclosure, meta information includes details about each SPA component, such as version, dependencies, functionality, and configuration requirements. This information is used by the intelligent deployment tool to accurately assemble and deploy the SPAs according to the specified configuration parameters.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The technology introduced in this disclosure pertains to an adaptive code packaging interface designed for customizable single page applications (SPAs). This interface enables independent software vendors (ISVs) to integrate multiple SPAs into a single container, allowing for more efficient and flexible development and deployment of merchant services solutions.

Currently, ISVs face significant challenges when attempting to use multiple SPAs within a single container to achieve desired functional outcomes. Each SPA typically requires its own environment and configuration, leading to increased complexity and inefficiency in the development and deployment process. Additionally, there is no streamlined method to dynamically assemble and deploy customized SPAs based on specific merchant requirements.

The solution proposed in this disclosure introduces a unique method for packaging custom-built code alongside existing SPAs. This method leverages intelligent deployment tools and prompt engineering with large language models (LLMs) to select and configure the appropriate SPA components based on customer requirements. These components are then processed and merged into a single deployment package, significantly simplifying the deployment process and enhancing the flexibility and efficiency of merchant services solutions.

Accordingly, the present disclosure proposes an adaptive code packaging interface that: (1) utilizes LLM and prompt engineering to gather merchant requirements and package the right solutions; (2) employs intelligent deployment processes using decentralized smart contract execution to ensure the correct version is installed for each merchant device; (3) allows for independent configuration and testing of each SPA component; and (4) provides the flexibility to add multiple SPA applications into a single deployment.

Furthermore, the present disclosure provides a technical solution to a technical problem. The technical problem includes the complexity and inefficiency associated with using multiple SPAs within a single container to achieve desired functional outcomes. The technical solution presented herein allows for the dynamic selection and configuration of SPA components, simplifying the deployment process and enhancing flexibility. Specifically, this solution is an improvement over existing methods by: (1) reducing the number of steps required to achieve the solution, thereby conserving computing resources such as processing power, storage, and network bandwidth; (2) providing a more accurate solution, reducing the resources needed to correct errors caused by less accurate methods; (3) eliminating manual input and inefficiencies, thereby improving the speed and efficiency of the process and conserving computing resources, and (4) determining the optimal amount of resources required for implementation, reducing network traffic and load on existing resources.

Furthermore, the technical solution described herein employs a rigorous, computerized process to perform tasks and activities that were not previously automated. In specific implementations, this solution bypasses several steps that were previously required, further conserving computing resources and streamlining the deployment process.

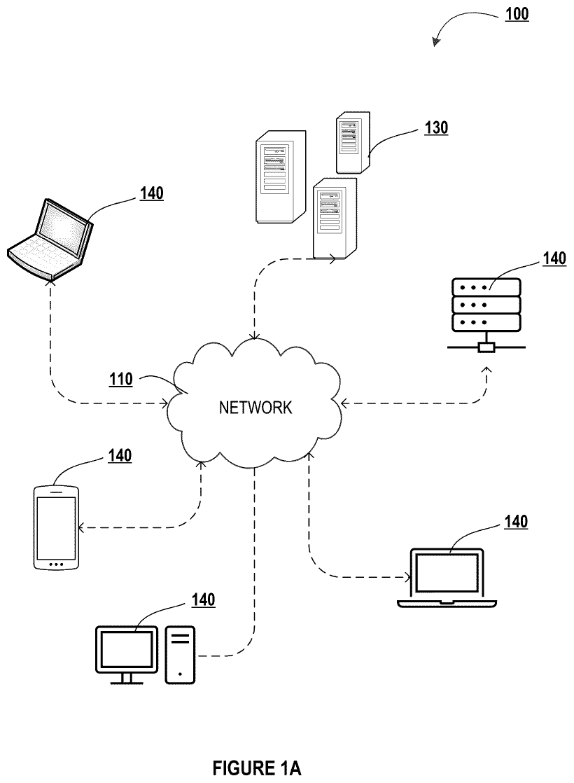

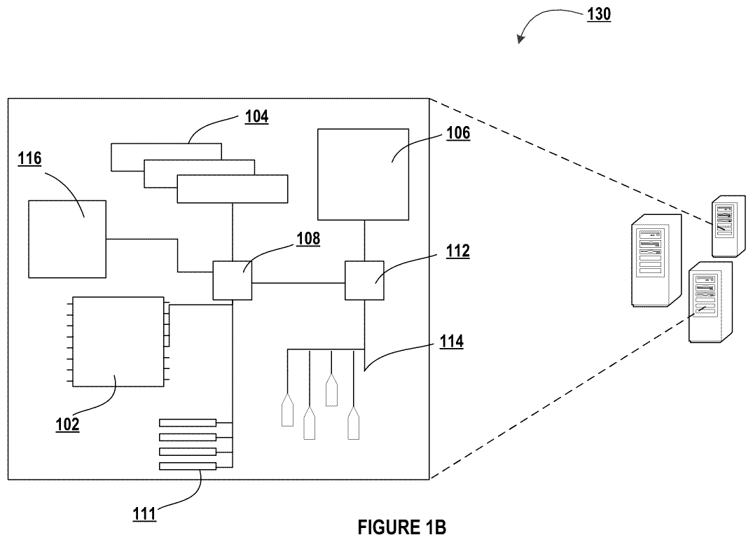

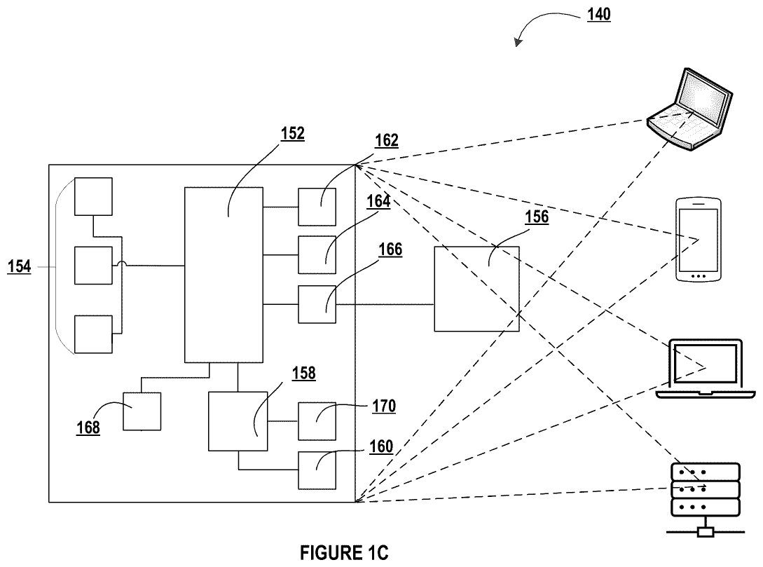

FIGS. 1A-1C illustrate technical components of an exemplary distributed computing environment 100 for adaptive code packaging interface for customizable single page application, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

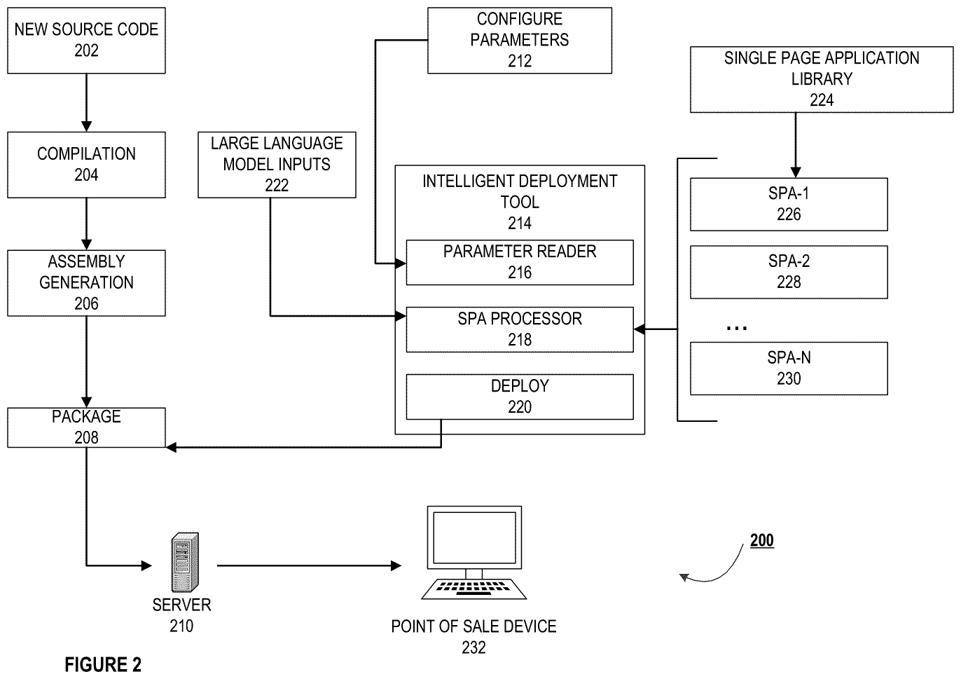

FIG. 2 illustrates a process flow 200 for adaptive code packaging interface for customizable single page application, in accordance with an embodiment of the disclosure. More specifically, FIG. 2 illustrates the process flow 200 for an adaptive code packaging interface for customizable single page applications (SPAs). This flow begins with the development of new source code 202, which is essential for creating the foundational elements of the application. Once the source code is written, it undergoes compilation 204, a process that converts the source code into executable code, ensuring that it is ready for further processing and integration into the system.

Following compilation, the next step is assembly generation 206. During this stage, the compiled code is organized into a cohesive assembly, which forms the building blocks for the final package. This step ensures that all components are correctly aligned and ready to be packaged together. The resulting assembly is then placed into a package 208, which serves as the deliverable unit for deployment. The packaged assembly is subsequently sent to a server 210 for storage and distribution. This server acts as a central repository, ensuring that the packaged application is accessible for deployment across various devices and platforms. The point of sale (POS) device 232 is one of the primary endpoints that will utilize the deployed application, ensuring seamless integration and functionality for end-users.

Simultaneously, the intelligent deployment tool 214 plays a crucial role in the customization and deployment process. This tool leverages large language model inputs 222 to intelligently select and configure the appropriate SPA components based on specific parameters set by the user 212. The configuration parameters 212 are critical for tailoring the deployment to meet unique customer requirements and preferences. Within the intelligent deployment tool 214, the parameter reader 216 interprets the provided configuration parameters, guiding the SPA processor 218 in assembling the correct components from the single page application library 224. The SPA processor 218 ensures that each selected SPA, such as SPA-1 226, SPA-2 228, through to SPA-N 230, is correctly integrated and ready for deployment. The final step in this intelligent process is deployment 220, where the configured and packaged SPAs are deployed to the relevant endpoints, such as the server 210 and subsequently to the POS device 232.

In summary, process flow 200 showcases a sophisticated method for developing, compiling, assembling, packaging, and deploying customizable single page applications. The integration of intelligent deployment tools, large language models, and precise configuration parameters ensures that the deployed applications meet specific user requirements, providing a flexible and efficient solution for various merchant services.

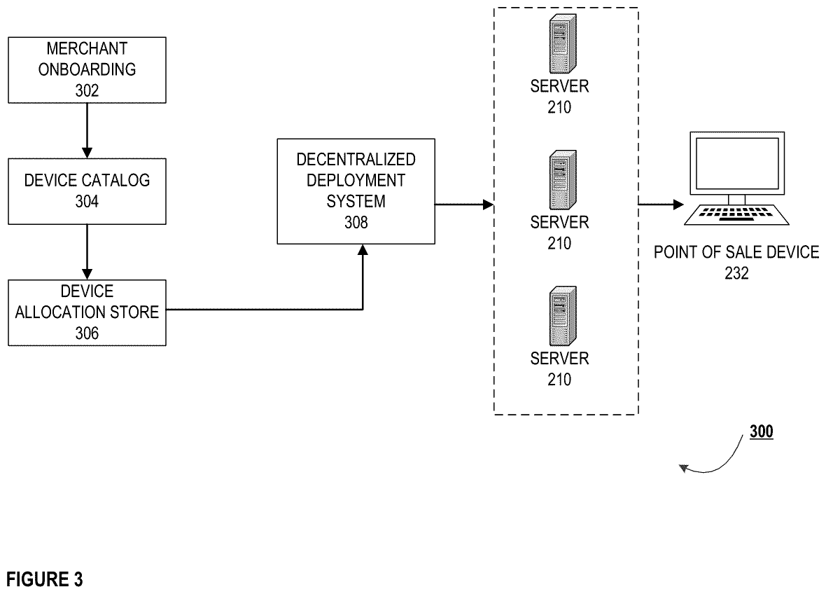

FIG. 3 illustrates a process flow 300 for adaptive code packaging interface for customizable single page application, in accordance with an embodiment of the disclosure. More specifically, FIG. 3 illustrates the process flow 300 for a decentralized deployment system designed to enhance the deployment of customizable single page applications (SPAs) using smart contracts. This process begins with the merchant onboarding step 302, where merchants provide their information for account opening. This information typically includes the domain of merchant services, the count and type of devices required, the operating schedule, and estimated volume, among other details.

Once the merchant onboarding step 302 is completed, the information is fed into the device catalog 304. The device catalog checks device availability and ensures that the necessary resources are listed for deployment. This step is crucial for maintaining an updated and accurate inventory of devices that can be allocated for various merchant needs. Next, the device allocation store 306 comes into play. This component stores the device allocation information, ensuring that the right devices are assigned to the correct merchants based on their specific requirements. The stored information includes details about the device's operational status, location, and configuration parameters, which are essential for the subsequent deployment steps.

The decentralized deployment system 308 is at the core of the process. It uses the information from the device allocation store 306 to manage the deployment of SPAs across multiple servers 210. The decentralized deployment system 308 leverages smart contracts to automate and ensure the accuracy of the deployment process. These smart contracts help identify if required DLLs and other server components need to be deployed, ensuring that each server has the correct version and configuration. The deployment is executed across multiple servers 210, which serve as the backbone for distributing the SPAs to various endpoints. These servers are interconnected and work together to ensure that the deployment process is efficient, secure, and scalable. The use of multiple servers ensures redundancy and high availability, which are critical for maintaining continuous service for merchants.

Finally, the deployed SPAs are made available to the point of sale device 232.

This device will have the application in a single container built by a number of SPAs, tailored to meet the specific needs of the merchant. The deployment process ensures that the point of sale device 232 is equipped with the latest updates and configurations, providing a seamless and efficient user experience. In summary, process flow 300 demonstrates a comprehensive method for deploying customizable single page applications using a decentralized system. The integration of smart contracts, device catalogs, and allocation stores ensures that the deployment is accurate, efficient, and tailored to the specific needs of each merchant, thereby enhancing the overall flexibility and scalability of merchant services solutions.

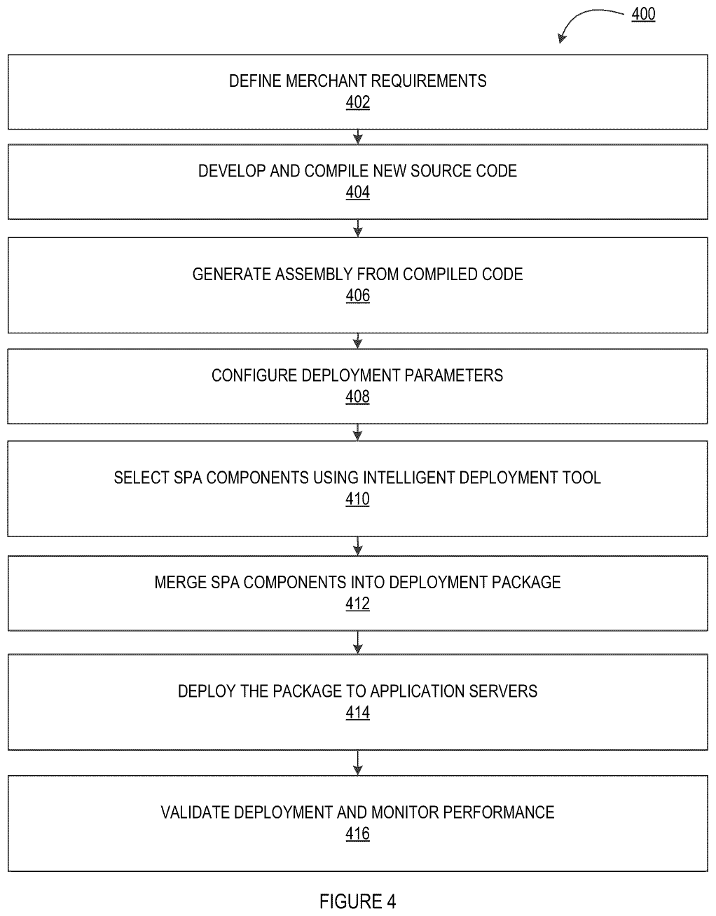

FIG. 4 illustrates a process flow for adaptive code packaging interface for customizable single page application, in accordance with an embodiment of the disclosure. As shown in block 402, the process begins with a thorough analysis of the merchant's requirements. This involves gathering detailed information about the services provided by the merchant, the operational environment, and any specific needs that must be addressed. Stakeholders collaborate to document these requirements, ensuring a comprehensive understanding of what the deployment must achieve. This step is critical for customizing the deployment to align with the merchant's business objectives. By clearly defining the requirements, the foundation is set for a deployment process that is both efficient and effective.

As shown in block 404, once the requirements are defined, the development team creates new source code tailored to meet those needs. This code includes custom functionalities and enhancements designed to optimize the merchant's operations. After the development phase, the source code is compiled into executable code. Compilation is a crucial step that transforms human-readable code into a format that can be executed by computers. During this phase, any syntax errors are identified and corrected, ensuring that the code is robust and ready for the next steps.

As shown in block 406, the compiled code is then organized into a structured assembly. Assembly generation involves grouping the compiled code and its dependencies into a cohesive unit. This step ensures that all components are correctly configured and ready to be packaged together. Proper assembly generation is vital for creating a functional deployment package. It lays the groundwork for a seamless integration and deployment, ensuring that all necessary elements are included and correctly configured.

Next, as shown in block 408, deployment parameters are configured to tailor the deployment process to the merchant's specific context. These parameters include settings such as server specifications, deployment environment, and any special instructions. Configuration ensures that the deployment package is customized to operate optimally within the merchant's infrastructure. This step is essential for achieving the desired performance and functionality. Proper configuration of parameters aligns the deployment with the operational requirements of the merchant.

As shown in block 410, with the deployment parameters set, the intelligent deployment tool selects the appropriate SPA components. This tool uses advanced algorithms and large language models to identify the best components based on the provided parameters. The tool reads meta information associated with each SPA component, ensuring compatibility and suitability. This selection process is crucial for assembling a deployment package that meets the merchant's needs efficiently. Intelligent selection of components enhances the flexibility and adaptability of the deployment.

As shown in block 412, selected SPA components are then merged into the deployment package along with the custom code. This integration process ensures that all components work together seamlessly. The deployment package includes all necessary configurations, dependencies, and instructions for deployment. Proper merging of components is essential for creating a functional and reliable deployment package. This step ensures that the final package is ready for deployment to the application servers, providing a cohesive and complete solution.

As shown in block 414, the deployment package is transferred to the application servers, where it is installed and configured. This step involves executing deployment scripts to ensure that the application is correctly set up and ready for use. Deployment to the servers is critical for making the application accessible to end-users. It marks the transition from development to operational use, ensuring that the application is available and functional. Successful deployment to the application servers is a key milestone in the deployment process.

As shown in block 416, the final step involves validating the deployment and monitoring the application's performance. Tests are conducted to ensure that the application functions as expected and meets all requirements. Performance monitoring helps identify any issues or areas for improvement. Ongoing validation and monitoring are essential for maintaining the application's reliability and performance over time. This step ensures that the deployment continues to meet the merchant's needs and provides a high-quality user experience.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for adaptive code packaging interface for customizable single page application, the system comprising:
a processing device;
a non-transitory storage device containing instructions when executed by the processing device, causes the processing device to perform the steps of:
generate merchant requirements by gathering and analyzing information specific to a merchant's services, operational environment, and needs;
compile source code based on the merchant requirements, including custom functionalities and enhancements necessary for a deployment package;
generate an assembly from the compiled source code by organizing the source code into a structured unit comprising necessary components and dependencies;
configure deployment parameters to tailor the deployment package to a merchant context comprising settings for server specifications and deployment environment;
transmit instructions to an intelligent deployment tool to select Single Page Application (SPA) components from a library via a large language model and prompt engineering to ensure compatibility and suitability;
merge the SPA components and the compiled source code into the deployment package;
deploy the deployment package to application servers via executing deployment scripts to install and configure the application; and
validate deployment via conducting one or more tests to ensure functionality and monitor application performance.

2. The system of claim 1, wherein the step of defining merchant requirements further comprises storing gathered information in a merchant database for future reference and analysis.

3. The system of claim 1, wherein the step of developing and compiling the source code includes using a version control system to manage changes and track history of the source code.

4. The system of claim 1, wherein the intelligent deployment tool further comprises a parameter reader that interprets the configuration parameters and guides the selection of the SPA components.

5. The system of claim 1, wherein the step of generating the assembly from the compiled source code comprises integrating third-party libraries and dependencies required for the SPA components.

6. The system of claim 1, wherein the deployment parameters include security settings to ensure a deployed application complies with one or more security policies and regulations of a merchant.

7. The system of claim 1, wherein validation further comprises automated testing tools to conduct functional, performance, and security tests on the deployed application.

8. A computer program product for adaptive code packaging interface for customizable single page application, the computer program product comprising a non-transitory computer-readable medium comprising code causing an apparatus to:
generate merchant requirements by gathering and analyzing information specific to a merchant's services, operational environment, and needs;
compile source code based on the merchant requirements, including custom functionalities and enhancements necessary for a deployment package;
generate an assembly from the compiled source code by organizing the source code into a structured unit comprising necessary components and dependencies;
configure deployment parameters to tailor the deployment package to a merchant context comprising settings for server specifications and deployment environment;
transmit instructions to an intelligent deployment tool to select Single Page Application (SPA) components from a library via a large language model and prompt engineering to ensure compatibility and suitability;
merge the SPA components and the compiled source code into the deployment package;
deploy the deployment package to application servers via executing deployment scripts to install and configure the application; and
validate deployment via conducting one or more tests to ensure functionality and monitor application performance.

9. The computer program product of claim 8, wherein the step of defining merchant requirements further comprises storing gathered information in a merchant database for future reference and analysis.

10. The computer program product of claim 8, wherein the step of developing and compiling the source code includes using a version control system to manage changes and track history of the source code.

11. The computer program product of claim 8, wherein the intelligent deployment tool further comprises a parameter reader that interprets the configuration parameters and guides the selection of the SPA components.

12. The computer program product of claim 8, wherein the step of generating the assembly from the compiled source code comprises integrating third-party libraries and dependencies required for the SPA components.

13. The computer program product of claim 8, wherein the deployment parameters include security settings to ensure a deployed application complies with one or more security policies and regulations of a merchant.

14. The computer program product of claim 8, wherein validation further comprises automated testing tools to conduct functional, performance, and security tests on the deployed application.

15. A method for adaptive code packaging interface for customizable single page application, the method comprising:
generate merchant requirements by gathering and analyzing information specific to a merchant's services, operational environment, and needs;
compile source code based on the merchant requirements, including custom functionalities and enhancements necessary for a deployment package;
generate an assembly from the compiled source code by organizing the source code into a structured unit comprising necessary components and dependencies;
configure deployment parameters to tailor the deployment package to a merchant context comprising settings for server specifications and deployment environment;
transmit instructions to an intelligent deployment tool to select Single Page Application (SPA) components from a library via a large language model and prompt engineering to ensure compatibility and suitability;
merge the SPA components and the compiled source code into the deployment package;
deploy the deployment package to application servers via executing deployment scripts to install and configure the application; and
validate deployment via conducting one or more tests to ensure functionality and monitor application performance.

16. The method of claim 15, wherein the step of defining merchant requirements further comprises storing gathered information in a merchant database for future reference and analysis.

17. The method of claim 15, wherein the step of developing and compiling the source code includes using a version control system to manage changes and track history of the source code.

18. The method of claim 15, wherein the intelligent deployment tool further comprises a parameter reader that interprets the configuration parameters and guides the selection of the SPA components.

19. The method of claim 15, wherein the step of generating the assembly from the compiled source code comprises integrating third-party libraries and dependencies required for the SPA components.

20. The method of claim 15, wherein validation further comprises automated testing tools to conduct functional, performance, and security tests on the deployed application.
